(19) United States
(12) Patent Application Publication
(10) Pub. No.: US 2024/0161257 A1
(43) Pub. Date: May 16, 2024

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventor: Seiya SHIBATA, Tokyo (JP)

(73) Assignee: NEC Corporation, Tokyo (JP)

(21) Appl. No.: 18/387,135

(22) Filed: Nov. 6, 2023

(30) Foreign Application Priority Data
Nov. 10, 2022 (JP) 2022-180590

(51) Int. Cl. G06T 7/00; G06V 10/75

(52) U.S. Cl. CPC G06T 7/00; G06V 10/751

(57) ABSTRACT

An information processing apparatus including: a first image processing unit that generates first information; a second image processing unit that generates second information; a first estimation unit that estimates whether or not the second image processing is able to be completed in a current processing period based on time needed for the first image processing and the first information; and a distribution unit that distributes, if it is estimated that the second image processing is not able to be completed in the current processing period, the first information to be used in remaining second image processing to the second image processing unit and a third image processing unit that is provided separately from the second image processing unit and executes the second image processing, in order to execute the remaining second image processing in a preset number of processing periods after the current processing period.

### CROSS-REFERENCE TO RELATED APPLICATION

This application is based upon and claims the benefit of priority from Japanese patent application No. 2022-180590, filed on Nov. 10, 2022, the disclosure of which is incorporated herein in its entirety by reference.

### BACKGROUND OF THE INVENTION

### 1. Field of the Invention

The present disclosure relates to an information processing apparatus, an information processing method, and a computer-readable recording medium.

### 2. Background Art

In cloud computing, a server computer (cloud server) on a cloud executes information processing using data collected from edge devices disposed in a peripheral edge portion (edge) of a computer network. However, if a communication delay, the network load, or the like increases, information processing may be affected. Therefore, edge computing has been proposed.

In edge computing, some of the information processing is executed using an edge device and a server computer (edge server) disposed in a peripheral area of the edge device, and the processed data is transmitted to a server computer on a cloud. In this way, in edge computing, supplementing the cloud computing reduces the influence of the communication delay, network load, and the like.

However, the performance of the edge device and the edge server is normally not high relative to the cloud server, and therefore if the amount of information to be processed increases, a processing delay may occur in the edge device and edge server.

As a related technique, in Patent Document 1 (Japanese Patent Laid-Open Publication No. 2022-74864), an information processing apparatus that reduces deficiency and excess of data to be transferred to a processing node that takes over data processing is disclosed. The information processing apparatus manages a plurality of processing nodes that each include a buffer and a processing unit that processes data retained in the buffer. Also, the information processing apparatus predicts the boundary between processed data and unprocessed data in the buffer at a predicted attainment time at which the resource load of a processing node that is performing data processing reaches a predetermined amount, and transfers, based on the prediction, the unprocessed data to another processing node that takes over data processing, in which a portion of the unprocessed data that is to be processed last is transferred first, and then a portion to be processed next to the transferred portion is transferred, and this transfer operation is repeated toward the boundary.

However, in the information processing apparatus in Patent Document 1, the estimation as to whether or not processing (processing on the edge side) to be executed by an edge device and an edge server that are used in the edge computing is to be allocated between the edge side and the cloud server (cloud side) is determined based on the resource load, and therefore the processing delay cannot be reduced.

### SUMMARY OF THE INVENTION

An example object of the disclosure is to reduce the processing delay by, if it is estimated that the processing on the edge side cannot be completed in a predetermined period, distributing the unprocessed portion of the remaining processing to the cloud side based on the processing content.

In order to achieve the above object, an information processing apparatus according to one aspect of the present disclosure includes:
a first image processing unit that generates first information by executing first image processing on an image acquired in each preset processing period;
a second image processing unit that generates second information by executing second image processing using the first information in the processing period;
a first estimation unit that estimates whether or not the second image processing is able to be completed in a current processing period based on time needed for the first image processing and the first information; and
a distribution unit that distributes, if it is estimated that the second image processing is not able to be completed in the current processing period, the first information to be used in remaining second image processing to the second image processing unit and a third image processing unit that is provided separately from the second image processing unit and executes the second image processing, in order to execute the remaining second image processing in a preset number of processing periods after the current processing period.

Also, in order to achieve the above object, an information processing method according to one aspect of the present disclosure is performed by an information processing apparatus, the method comprising:
generating first information by executing first image processing on an image acquired in each preset processing period;
generating second information by executing second image processing using the first information in the processing period;
estimating whether or not the second image processing is able to be completed in a current processing period based on time needed for the first image processing and the first information; and
distributing, if it is estimated that the second image processing is not able to be completed in the current processing period, the first information to be used in remaining second image processing to the information processing apparatus and another information processing apparatus that is provided separately from the information processing apparatus and executes the second image processing, in order to execute the remaining second image processing in a preset number of processing periods after the current processing period.

Furthermore, in order to achieve the above object, a computer-readable recording medium according to one aspect of the present disclosure includes a program recorded thereon, the program including instructions that causes a computer to carry out:
generating first information by executing first image processing on an image acquired in each preset processing period;
generating second information by executing second image processing using the first information in the processing period;
estimating whether or not the second image processing is able to be completed in a current processing period based on time needed for the first image processing and the first information; and
distributing, if it is estimated that the second image processing is not able to be completed in the current processing period, the first information to be used in remaining second image processing to the computer and another computer that is provided separately from the computer and executes the second image processing, in order to execute the remaining second image processing in a preset number of processing periods after the current processing period.

As described above, according to the present disclosure, if it is estimated that the processing on the edge side cannot be completed in a predetermined period, distributing the unprocessed portion of the remaining processing to the cloud side based on the processing content, and thus it is possible to reduce the processing delay.

### BRIEF DESCRIPTION OF THE DRAWINGS

FIG. 1 is a diagram for describing an example of the system of the first example embodiment.

FIG. 2 is diagram for describing an example of the system operation of the first example embodiment.

FIG. 3 is diagram for describing an example of the system operation of the first example embodiment.

FIG. 4 is a diagram illustrating an example of the operations of the edge-side information processing apparatus of the first example embodiment.

FIG. 5 is a diagram for describing an example of the system of the second example embodiment.

FIG. 6 is a diagram for describing an example of the system operation of the second example embodiment.

FIG. 7 is a diagram for describing an example of the operations of the edge-side information processing apparatus of the second example embodiment.

FIG. 8 is a diagram for describing an example of the system of the first working example.

FIG. 9 is a diagram for describing an example of the system of the second working example.

FIG. 10 is a diagram for describing an example of a computer that realizes the information processing apparatus in the first and second example embodiments and the first and second working examples.

### EXEMPLARY EMBODIMENTS

Hereinafter, example embodiments will be described with reference to the drawings. Note that, in the drawings described below, the elements that have the same or corresponding functions are given the same reference numerals and description thereof may not be repeated.

### First Example Embodiment

In a first example embodiment, an information processing apparatus on an edge side that is provided in a system that realizes edge computing executes predetermined processing in each of a plurality of processing periods.

When the edge-side information processing apparatus estimates that the predetermined processing cannot be completed in a current processing period, the remaining processing that is a portion of the predetermined processing that cannot be executed in the current processing period is executed by the edge-side information processing apparatus and a cloud-side information processing apparatus, in a period after the current processing period.

Specifically, if there is a spare period in which the remaining processing can be executed in one or more processing periods after the current processing period, the edge-side information processing apparatus executes the remaining processing using the spare period. The cloud-side information processing apparatus is also caused to execute the remaining processing as soon as possible.

Thereafter, a processing result corresponding to the remaining processing is acquired from the apparatus, of the edge-side information processing apparatus and the cloud-side information processing apparatus, that was quicker to complete the remaining processing.

That is, if the edge-side information processing apparatus was quicker to complete the remaining processing than the cloud-side information processing apparatus, the result of remaining processing executed in the edge-side information processing apparatus is acquired. In contrast, if the cloud-side information processing apparatus was quicker to complete the remaining processing than the edge-side information processing apparatus, the result of remaining processing executed in the cloud-side information processing apparatus is acquired.

As described above, in the first example embodiment, the processing result corresponding to the remaining processing can be acquired from the apparatus that was quicker to complete the remaining processing, and therefore the processing delay can be made shorter than in the conventional technique.

For example, there are cases where the edge-side information processing apparatus cannot secure sufficient spare periods in processing periods after the current processing period, and therefore cannot complete the remaining processing sooner. In such a case as well, cloud-side information processing apparatus executes the remaining processing. Then, if the cloud-side information processing apparatus has completed the remaining processing quicker, the result of the remaining processing executed by the cloud-side information processing apparatus is used. As a result, the remaining processing that was planned to be executed in the current processing period can be completed quicker than the case where this technique is not used, and therefore the processing delay in the overall processing can be reduced.

[System Configuration]

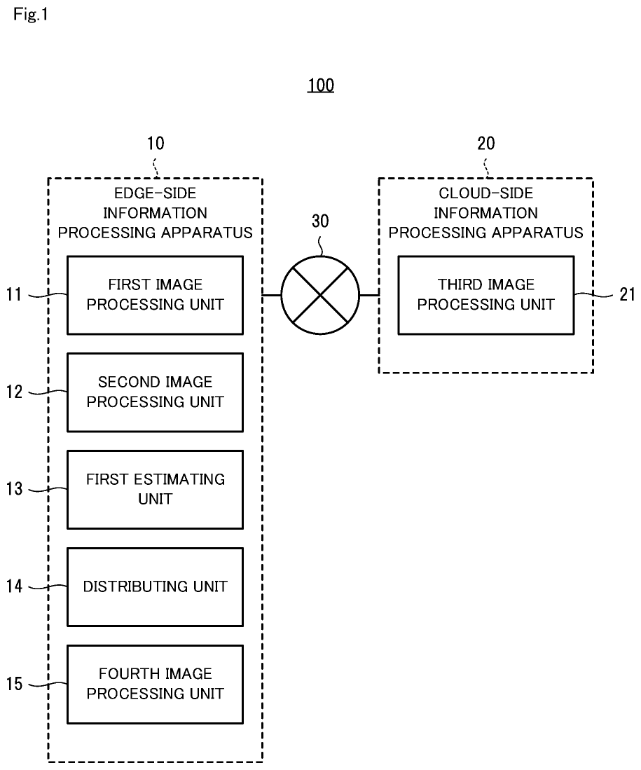

The first example embodiment will be described in detail using FIG. 1. FIG. 1 is a diagram for describing an example of the system of the first example embodiment.

A system 100 is a system for realizing edge computing. The system 100 in FIG. 1 includes an information processing apparatus 10 provided on an edge side, an information processing apparatus 20 provided on a cloud side, and a network 30. Also, the information processing apparatus 10 and the information processing apparatus 20 communicate with each other via the network 30.

The information processing apparatus 10 is a CPU (Central Processing Unit), a programmable device such as an FPGA (Field-Programmable Gate Array), or a GPU (Graphics Processing Unit), or a circuit, a server computer, a personal computer, a mobile terminal, or the like on which at least one of the devices is mounted.

The information processing apparatus 20 is a CPU, a programmable device such as an FPGA, or a GPU, or a circuit, at least one server computer, or the like on which at least one of the devices is mounted.

The network 30 is a common communication network constructed using a communication line such as the Internet, a LAN (Local Area Network), a dedicated line, a telephone line, an intranet, a mobile communication network, Bluetooth (registered trademark), or WiFi (Wireless Fidelity)

The edge-side information processing apparatus 10 will be described.

The information processing apparatus 10 includes a first image processing unit 11, a second image processing unit 12, a first estimating unit 13, a distributing unit 14, and a fourth image processing unit 15, as shown in FIG. 1.

The first image processing unit 11 acquires an image for each preset processing period T1 in time series, and generates first information by executing first image processing on the acquired image. The images are acquired, in time series, from an image processing device or a storage device, for example.

The first information is information to be used in later-described second image processing. Also, the first information includes a plurality of pieces of input data to be used in the second image processing.

In a processing period T1, the second image processing unit 12 generates second information by executing the second image processing using the first information. The second information is information to be used in later-described third image processing.

The first estimating unit 13 estimates whether or not the second image processing can be completed in a current processing period T1_0, based on the time (period Ti1) needed for the first image processing and the first information generated in the first image processing.

Specifically, the first estimating unit 13 estimates the time (period Ti2) that can be used for the second image processing in the current processing period T1_0, and estimates whether the second image processing can be completed in the estimated period Ti2 using the first information.

As the method of estimating whether the second image processing can be completed in the period Ti2, a method is conceivable in which a processing time (average or worst) t2 of the second image processing in the information processing apparatus 10 is measured, in advance, with respect to one piece of input data of the second image processing, and a comparison is made, in terms of the length, between Ti2 and t2×n, using the number of data n included in the first information, for example.

As described above, as a result of using the change factor (number of input data, in the prior example) of processing time that can be simply understood at the time of execution and the value (average value or worst value) of the processing time (processing time for one piece of input data, in the prior example) with respect to one unit of the change factor that can be understood in advance, the processing time needed for the second image processing can be estimated, and whether the second image processing can be completed can be estimated by comparing the estimated processing time with the period Ti2.

When it is estimated that the second image processing cannot be completed in the current processing period T1_0, the distributing unit 14 distributes the first information to be used in the remaining second image processing to the second image processing unit 12 and a third image processing unit 21 that is provided separately from the second image processing unit 12 and executes the second image processing, in order to execute the remaining second image processing in a preset number of processing periods (period T3) after the current processing period T1_0.

Specifically, in the first example embodiment, the distributing unit 14 distributes all of the first information to be used in the remaining second image processing to the second image processing unit 12 and the third image processing unit 21, in order to execute the remaining second image processing in a preset number of processing periods (period T3) after the current processing period T1_0.

Note that, when the first information desired to be processed, in the second image processing, in the current processing period T1_0 includes 100 pieces of input data, if 60 pieces of input data of the first information has been actually used, in the second image processing, in the current processing period T1_0, the first information to be used in the remaining second image processing includes 40 pieces of input data.

When the first information to be used in the remaining second image processing is distributed, the second image processing unit 12 executes the second image processing using all of the first information to be used in the remaining second image processing, in spare periods, in a preset number of processing periods (period T3) after the current processing period T1_0, in which the remaining second image processing can be executed. Also, in the third image processing unit 21, the second image processing is executed using all of the first information to be used in the remaining second image processing.

The fourth image processing unit 15 acquires second information generated in the remaining second image processing from one of the second image processing unit 12 and the third image processing unit 21 that has completed the remaining second image processing quicker. Also, the fourth image processing unit 15 executes third image processing using the second information generated in the current processing period T1_0 and the second information generated in the preset number of processing periods (period T3) after the current processing period T1_0.

Cloud-side information processing apparatus 20 will be described.

The information processing apparatus 20 includes above-mentioned third image processing unit 21, as shown in FIG. 1. Note that, in the example in FIG. 1, the fourth image processing unit 15 is provided in the edge-side information processing apparatus 10, but may be provided in the cloud-side information processing apparatus 20.

The third image processing unit 21 first receives, via the network 30, all of the first information to be used in the remaining second image processing transmitted from the distributing unit 14. Next, the third image processing unit 21 generates second information by executing the second image processing using all of the acquired first information to be used in the remaining second image processing. Next, the third image processing unit 21 transmits the generated second information to the fourth image processing unit 15 via the network 30.

[System Operation]

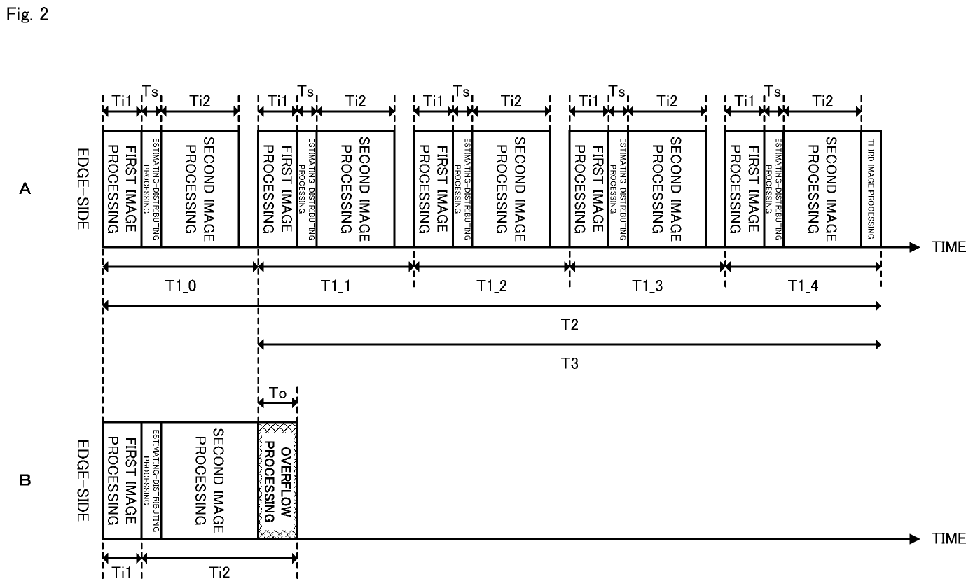

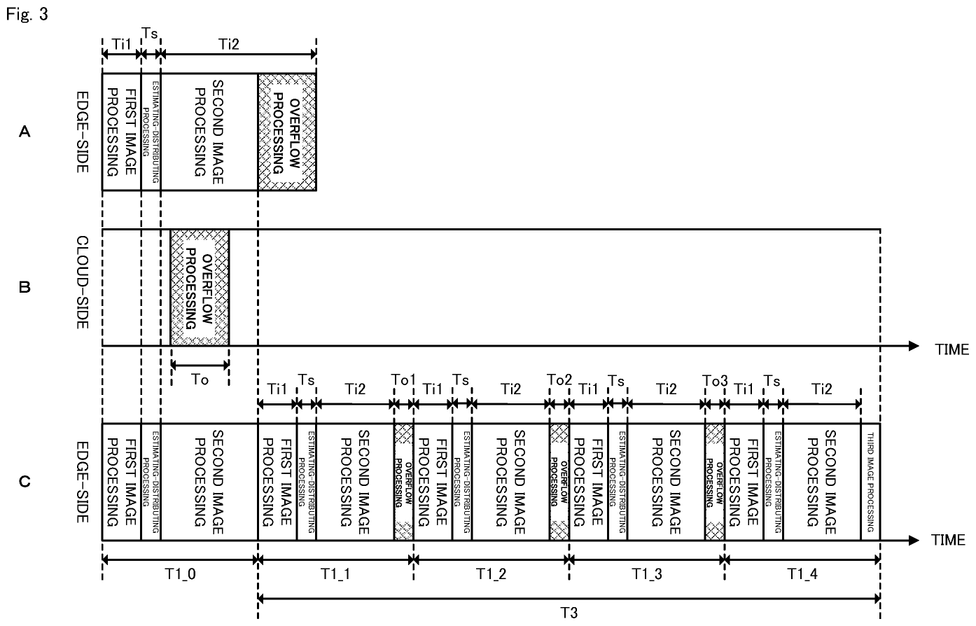

FIGS. 2 and 3 are diagrams for describing an example of the system operation of the first example embodiment. A period T2 of A in FIG. 2 includes five processing periods T1_0, T1_1, T1_2, T1_3, and T1_4. Note that the number of processing periods is not limited to five.

Also, A of FIG. 2 shows an example in which the first image processing and second image processing are completed in the processing periods T1_0, T1_1, T1_2, T1_3, and T1_4, and the third image processing is completed in the processing period T1_4. That is, in the case of A of FIG. 2, the first image processing, second image processing, and third image processing can be completed in the period T2 by the edge-side information processing apparatus 10 alone.

However, as in B of FIG. 2, there are cases where, in the processing period T1_0, the second image processing is not completed in the processing period T1_0, and an unprocessed portion of the second image processing remains. Then, in a period Ts shown in A of FIG. 3, the first estimating unit 13 estimates whether or not the second image processing can be completed in the current processing period T1_0 based on the time Ti1 needed for the first image processing and the first information.

Next, if the first estimating unit 13 has estimated that the second image processing cannot be completed in the current processing period T1_0, the distributing unit 14 distributes the first information to be used in the remaining second image processing to the second image processing unit 12 and the third image processing unit 21, in order to execute the remaining second image processing in a period T3 after the current processing period T1_0.

Specifically, the distributing unit 14 transmits all of the first information to be used in the remaining second image processing to the third image processing unit 21 of the cloud-side information processing apparatus 20 via the network 30. Next, as shown in B of FIG. 3, the third image processing unit 21 executes the remaining second image processing in a period To using all of the first information.

Also, as shown in C of FIG. 3, the second image processing unit 12 executes the second image processing (overflow processing) that can be executed in spare periods To1, To2, and To3 of respective processing periods T1_1, T1_2, and T1_3, in the spare periods To1, To2, and To3, using the first information to be used in the remaining second image processing.

Next, the fourth image processing unit 15 acquires second information generated in the remaining second image processing from the one of the second image processing unit 12 and the third image processing unit 21 that was quicker to complete the remaining second image processing. In the case of C of FIG. 3, the cloud side third image processing unit 21 was quicker to complete the remaining second image processing, and therefore, the fourth image processing unit 15 acquires the second information from the third image processing unit 21.

Next, the fourth image processing unit 15 executes the third image processing using all pieces of the second information that were respectively generated in the processing periods T1_0, T1_1, T1_2, T1_3, and T1_4.

[Apparatus Operations]

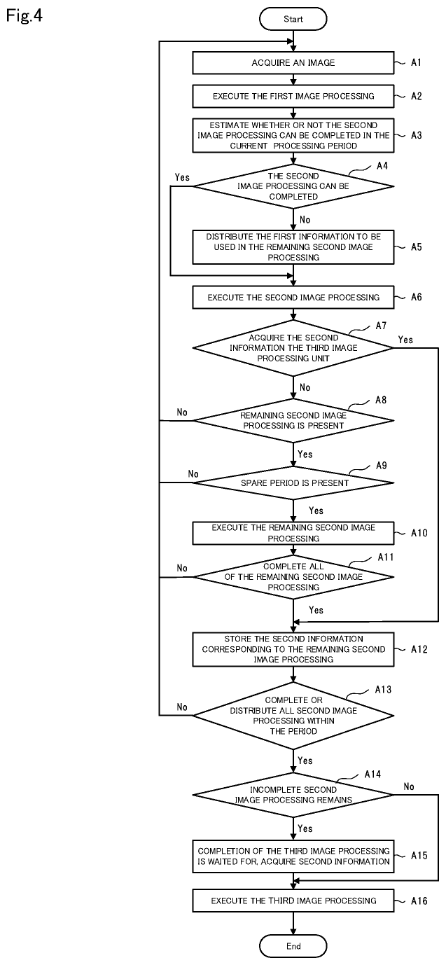

Next, operations of the edge-side information processing apparatus 10 in the first example embodiment will be described using FIG. 4. FIG. 4 is a diagram illustrating an example of the operations of the edge-side information processing apparatus of the first example embodiment. In the following description, the drawings will be referred to as appropriate. Furthermore, in the first example embodiment, an information processing method is implemented by causing the information processing apparatus 10 to operate. Accordingly, the following description of the operations of the information processing apparatus replaces the description of the information processing method in the first example embodiment.

As shown in FIG. 4, the first image processing unit 11 acquires an image for each processing period T1 in time series (step A1). Next, the first image processing unit 11 generates first information by executing the first image processing, and stores the generated first information in a memory (step A2). Note that, in step A2, the time needed for the first image processing (period Ti1) is measured.

Next, the first estimating unit 13 estimates whether or not the second image processing can be completed in the current processing period T1_0 based on the time needed for the first image processing (period Ti1) and the first information generated in the first image processing (step A3).

Specifically, in step A3, the first estimating unit 13 estimates the time, in the current processing period T1_0, that can be used for the second image processing (period Ti2), and estimates whether or not the second image processing can be completed in the estimated period Ti2 using the first information.

Next, if it is determined that the second image processing cannot be completed in the current processing period T1_0 (step A4: No), the distributing unit 14 distributes the first information to be used in the remaining second image processing to the second image processing unit 12 and the third image processing unit 21 that is provided separately from the second image processing unit 12 and executes the second image processing, in order to execute the remaining second image processing in a preset number of processing periods (period T3) after the current processing period T1_0 (step A5).

Specifically, in step A5, the distributing unit 14 distributes all of the first information to be used in the remaining second image processing in the preset number of processing periods (period T3) after the current processing period T1_0 to the second image processing unit 12 and the third image processing unit 21. Note that the third image processing unit 21 generates second information by executing the second image processing using all of the first information to be used in the remaining second image processing.

If it is determined that the second image processing can be completed in the current processing period T1_0 (step A4: Yes), the distributing unit 14 moves the processing to the processing in step A6.

Next, the second image processing unit 12 generates, in the current processing period T1_0, second information by executing the second image processing using the first information that is not used in the remaining second image processing, and stores the generated second information in a memory (step A6).

Next, if the fourth image processing unit 15 has acquired the second information corresponding to the remaining second image processing from the third image processing unit 21 (step A7: Yes), that is, if the third image processing unit 21 has generated second information corresponding to the remaining second image processing quicker than the second image processing unit 12, the fourth image processing unit 15 stores the second information corresponding to the remaining second image processing in a memory (step A12).

Note that the second information in step A7 includes, not only the result of distribution in step A5 immediately prior, but also the second information as a result of distribution in step A5 in previous loops (T1_0 with respect to T1_1, etc.).

Also, if the second information corresponding to the remaining second image processing has not been received from the third image processing unit 21 (step A7: No), the processing is moved to processing in step A8.

Next, if remaining second image processing is present (step A8: Yes), and if a spare period is present (step A9: Yes), the second image processing unit 12 executes the second image processing, in the spare period, using the first information to be used in the remaining second image processing (step A10).

Also, if remaining second image processing is not present (step A8: No), and if a spare period is not present (step A9: No), the processing is moved to processing in step A1.

Next, if the second image processing unit 12 has completed all of the remaining second image processing (step A11: Yes), the second image processing unit 12 stores the second information corresponding to the remaining second image processing in a memory (step A12). Also, if the second image processing unit 12 has not completed all of the remaining second image processing (step A11: No), the processing is moved to processing in step A1.

Next, if all of the second image processing has been completed or distributed in each of the processing periods in the period T3 (step A13: Yes), and incomplete second image processing remains (step A14: Yes), completion of the third image processing is waited for, and second information is acquired (step A15). Thereafter, the fourth image processing unit 15 executes the third image processing using all of the second information generated in the respective processing periods in the period T3 (step A16).

Also, if all of the second image processing has been completed or distributed in each of the processing periods in the period T3 (step A13: Yes), and there is no incomplete second image processing (step A14: No), the fourth image processing unit 15 executes the third image processing using all of the second information generated in the respective processing periods in the period T3 (step A16).

Note that, if all of the second image processing has not been completed or distributed in the processing periods in the period T3 (step A13: No), the fourth image processing unit 15 moves the processing to processing in step A1.

Note that, in the first example embodiment, the processing from step A1 to step A16 is repeatedly executed.

[Effects of First Example Embodiment]

As described above, according to the first example embodiment, the second information generated in the remaining second image processing is acquired from the one of the second image processing unit 12 and the third image processing unit 21 that was quicker to complete the remaining second image processing, and as a result, the processing delay in the overall processing can be reduced.

[Program]

A program according to the above of the first example embodiment may be a program that causes a computer to execute steps A1 to A6 shown in FIG. 4. By installing this program in a computer and executing the program, the information processing apparatus and the information processing method edge-side according to the first example embodiment can be realized. In this case, the processor of the computer functions as the first image processing unit 11, the second image processing unit 12, the first estimating unit 13, the distributing unit 14 and the fourth image processing unit 15, and performs processing.

Also, the program according to the first example embodiment may be executed by a computer system constructed by a plurality of computers. In this case, each computer may function as any of the first image processing unit 11, the second image processing unit 12, the first estimating unit 13, the distributing unit 14 and the fourth image processing unit 15.

### Second Example Embodiment

In a second example embodiment, an edge-side information processing apparatus provided in a system that realizes edge computing executes predetermined processing in each of a plurality of processing periods.

When the edge-side information processing apparatus estimates that the predetermined processing cannot be completed in a current processing period, the remaining processing that is a portion of the predetermined processing that has not been executed in the current processing period is executed by the edge-side information processing apparatus and a cloud-side information processing apparatus, in a period after the current processing period.

Specifically, the edge-side information processing apparatus estimates whether or not a spare period for executing the remaining processing is present in each of one or more processing periods after the current processing period.

Next, upon estimating that a spare period is present, the edge-side information processing apparatus executes the remaining processing using the spare period. In contrast, if it is estimated that there is no spare period, a cloud-side information processing apparatus is caused to execute the remaining processing at an earlier timing.

As described above, in the second example embodiment, the edge-side information processing apparatus and the cloud-side information processing apparatus share the processing, the processing results corresponding to the remaining processing are acquired from the two apparatuses, and as a result. the remaining processing that was planned to be executed in the processing period can be completed earlier, and thus the processing delay can be made shorter than the conventional technique.

[System Configuration]

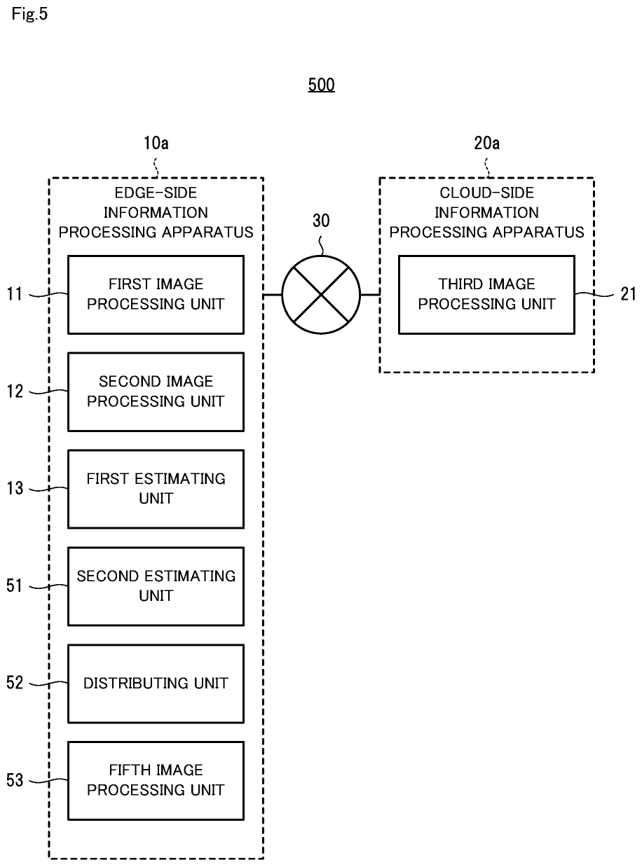

The second example embodiment is described in detail using FIG. 5. FIG. 5 is a diagram for describing an example of the system of the second example embodiment.

A system 500 is a system for realizing edge computing. The system 500 in FIG. 5 includes an information processing apparatus 10a provided on the edge side, an information processing apparatus 20a provided on the cloud side, and the network 30. Also, the information processing apparatus 10a and the information processing apparatus 20a communicate with each other via the network 30.

Note that the description of the pieces of hardware of the information processing apparatus 10a, information processing apparatus 20a, and network 30 are the same as that of the information processing apparatus 10, information processing apparatus 20, and network 30 shown in FIG. 1, and therefore the description thereof will be omitted.

The edge-side information processing apparatus 10a will be described.

The information processing apparatus 10a includes the first image processing unit 11, the second image processing unit 12, the first estimating unit 13, a second estimating unit 51, a distributing unit 52, and a fifth image processing unit 53, as shown in FIG. 5.

Note that the first image processing unit 11, second image processing unit 12, and first estimating unit 13 have been described in the first example embodiment, and therefore the description thereof will be omitted.

If it is estimated that the second image processing cannot be completed in a current processing period T0_1, the second estimating unit 51 estimates whether or not a spare period in which the remaining second image processing can be executed is present in a processing period after the current processing period T1_0 based on a change between a first image acquired in the processing period and a second image acquired in a processing period prior to the processing period.

The change between the first image and the second image is the difference between the pixels of the first image and the pixels of the second image. A pixel difference Sub can be calculated using the following formula shown as Math. 1, where an image has a width W and a height H, the value of a pixel at a pixel position (x, y) of the first image is denoted as p1, and the value of a pixel at a pixel position (x, y) of the second image is denoted as p2, for example. Note that p1 and p2 are each expressed by a 24-bit value in which three channels of RGB colors are each expressed by an 8-bit value (or 32-bit value containing the 24-bit value), or a floating point 16-bit value or 32-bit value obtained by performing normalization.

$$Sub = {\sum }_{y = 0}^{H - 1} {\sum }_{x = 0}^{W - 1} \vert p 1 - p 2 \vert \qquad [ Math . 1 ]$$

Sub: pixel difference
W: image width
H: image height
p1: pixel position of first image
p2: pixel position of second image

Regarding estimation as to whether or not a spare period is present, it is estimated that a spare period is present if the pixel difference Sub is a preset difference threshold Tha or less (Sub≤Tha). That is, as the pixel difference increases, the change between images increases, and accordingly the second image processing increases, and therefore it is expected that the spare period relatively decreases. Also, as the difference decreases, the time taken for the second image processing decreases, and therefore it is expected that the spare period relatively increases.

Note that it is conceivable that the difference threshold Tha is determined through experiments, simulations, or the like in advance.

If it is estimated that there is no spare period, the distributing unit 52 distributes the first information to be used in the remaining second image processing to the third image processing unit 21. Then, the third image processing unit 21 executes the second image processing using the distributed first information.

In contrast, if it is estimated that a spare period is present, the second image processing unit 12 executes the second image processing in the spare period using the first information to be used in the remaining second image processing.

The fifth image processing unit 53 acquires the second information generated by the second image processing unit 12 and the third image processing unit 21, and executes the third image processing using the acquired second information.

The cloud-side information processing apparatus 20a will be described.

The information processing apparatus 20a includes the aforementioned third image processing unit 21, as shown in FIG. 5. Note that, in the example in FIG. 5, the fifth image processing unit 53 is provided in the edge-side information processing apparatus 10a, but may be provided in the cloud-side information processing apparatus 20a. Note that the third image processing unit 21 has already been described in the first example embodiment, and therefore the description thereof will be omitted.

[System Operation]

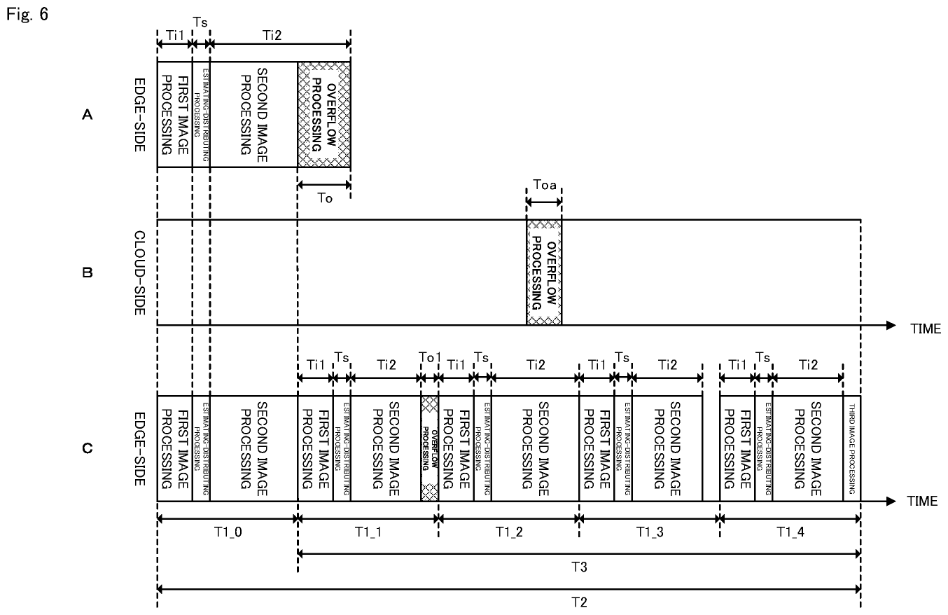

FIG. 6 is a diagram for describing an example of the system operation of the second example embodiment. Note that a period T2 in C of FIG. 6 includes five processing periods T1_0, T1_1, T1_2, T1_3, and T1_4. However, the number of processing periods is not limited to five.

Also, C of FIG. 6 shows an example in which the first image processing and the second image processing are completed in the processing periods T1_0, T1_1, T1_2, T1_3, and T1_4, and the third image processing is completed in the processing period T1_4.

There are cases where, in the processing period T1_0, the second image processing is not completed in the processing period T1_0, and an unprocessed portion of the second image processing remains, as shown in A of FIG. 6. In such a case, in a period Ts shown in C of FIG. 6, the first estimating unit 13 estimates whether or not the second image processing can be completed in the current processing period T1_0 based on the time Ti1 needed for the first image processing and the first information.

Next, if it is estimated that the second image processing cannot be completed in the current processing period T1_0, the second estimating unit 51 estimates whether or not a spare period is present in the processing period T1_1 after the current processing period T1_0.

Specifically, the second estimating unit 51 estimates whether or not a spare period in which the remaining second image processing can be executed is present in the processing period T1_1 based on the change of a first image acquired in the processing period T1_1 after the current processing period T1_0 from a second image acquired in the processing period T1_0 prior to the processing period T1_1.

In C of FIG. 6, it is estimated that a spare period is present in the processing period T1_1, and therefore the second image processing (overflow processing) is executed in a spare period To1 using first information to be used in the remaining second image processing.

Next, in C of FIG. 6, it is estimated that there is no spare period in the current processing period T1_2, and thus the distributing unit 52 distributes a portion of the first information, of the pieces of first information output in the processing periods T1_0, T1_1, and T1_2, that has not been input to the second image processing to the third image processing unit 21.

Thereafter, as shown in B of FIG. 6, in a period Toa, the third image processing unit 21 executes the second image processing using first information that was not used in the spare period To1.

Next, the fifth image processing unit 53 acquires second information generated by both of the second image processing unit 12 and the third image processing unit 21. In the case of C of FIG. 6, the fifth image processing unit 53 executes the third image processing using the second information generated by the second image processing unit 12 and third image processing unit 21.

[Apparatus Operations]

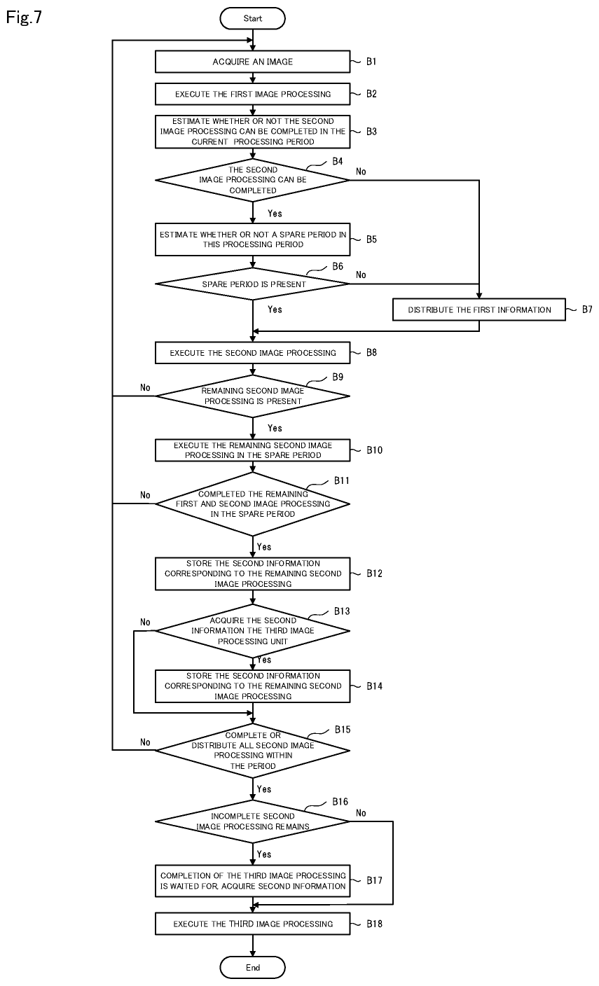

Operations of the edge-side information processing apparatus 10a in the second example embodiment will be described using FIG. 7. FIG. 7 is a diagram for describing an example of the operations of the edge-side information processing apparatus of the second example embodiment. In the following description, the drawings will be referred to as appropriate. Furthermore, in the second example embodiment, an information processing method is implemented by causing the information processing apparatus 10a to operate. Accordingly, the following description of the operations of the information processing apparatus replaces the description of the information processing method in the second example embodiment.

As shown in FIG. 7, the first image processing unit 11 acquires an image for each processing period T1 in time series (step B1). Next, the first image processing unit 11 generates first information by executing the first image processing, and stores the generated first information in a memory (step B2). Note that, in step B2, the time needed for the first image processing (period Ti1) is measured.

Next, the first estimating unit 13 estimates whether or not the second image processing can be completed in the processing period based on the time (period Ti1) needed for the first image processing and the first information generated in this first image processing (step B3).

Specifically, in step B3, the first estimating unit 13 estimates the time (period Ti2), in the processing period T1, that can be used for second image processing, and estimates whether the second image processing can be completed in the estimated period Ti2 using the first information. Next, if it is estimated that the second image processing can be completed in the processing period T1 (step B4: Yes), the second estimating unit 51 estimates whether or not a spare period in which the remaining second image processing can be executed is present in this processing period (step B5).

Specifically, in the case of C FIG. 6, in step B5, it is estimated whether or not a spare period To1 is present in the processing period T1_1 based on the change between a first image acquired in the processing period T1_1 and a second image acquired in the processing period T1_0 prior to the processing period T1_1.

If it is estimated that the second image processing cannot be completed in the current processing period T1_0 (step B4: No), the distributing unit 52 moves the processing to processing in step B7.

Next, if it is estimated that a spare period in which the remaining second image processing can be executed is present in this processing period (step B6: Yes), the processing is moved to processing in step B8.

Also, if it is estimated that there is no spare period in which the remaining second image processing can be executed in this processing period (step B6: No), the distributing unit 52 distributes the first information to be used in the remaining second image processing to the third image processing unit 21 (step B7). Also, the third image processing unit 21 executes the second image processing using the distributed first information.

Next, the second image processing unit 12 generates, in the processing period T1, second information by executing the second image processing using first information that is not to be used in the remaining second image processing, and stores the generated second information in a memory (step B8).

Next, if a spare period is present (step B6: Yes), and remaining second image processing is present (step B9: Yes), the second image processing unit 12 executes the second image processing using the first information to be used in the remaining second image processing in the spare period (step B10).

Next, if the second image processing unit 12 has completed the remaining second image processing in the spare period (step B11: Yes), the second image processing unit 12 stores the second information corresponding to the remaining second image processing in the spare period in a memory (step B12). Also, if the remaining first and second image processing in the spare period has not been completed (step B11: No), the processing is moved to processing in step B1.

Next, if the second information (result of executing the second image processing on distributed first information) is acquired from the third image processing unit 21 (step B13: Yes), the fifth image processing unit 53 stores the acquired second information in a memory (step B14).

Also, if the fifth image processing unit 53 has not acquired the second information from the third image processing unit 21 (step B13: No), the processing is moved to processing in step B15.

Next, if all second image processing has been completed or distributed in each processing period T1 of the period T3 (step B15: Yes), and uncompleted second image processing remains (step B16: Yes), completion of the third image processing is waited for, and then the second information is acquired (step B17). Thereafter, the fifth image processing unit 53 executes the third image processing using all pieces of second information that were generated in the respective processing periods of period T3 (step B18).

Also, if all second image processing has been completed or distributed in each processing period T1 of the period T3 (step B15: Yes), and there is no uncompleted second image processing (step B16: No), the fifth image processing unit 53 executes the third image processing using all pieces of second information that are generated in the respective processing periods of period T3 (step B18).

If all second image processing has not been completed or distributed in some of the processing periods T1 of period T3 (step B15: No), the fifth image processing unit 53 moves the processing to processing in step B1.

Note that, in the second example embodiment, the processing from step B1 to step B18 is repeatedly executed.

[Effects of Second Example Embodiment]

As described above, according to the second example embodiment, the processing is shared between the second image processing unit 12 and the third image processing unit 21, second information generated in the remaining second image processing is acquired from both of the image processing units, and as a result, the remaining second image processing that was planned to be executed in the processing period can be completed earlier, and thus the processing delay can be made shorter than the conventional technique.

[Program]

A program according to the above of the second example embodiment may be a program that causes a computer to execute steps B1 to B18 shown in FIG. 7. By installing this program in a computer and executing the program, the information processing apparatus and the information processing method edge-side according to the second example embodiment can be realized. In this case, the processor of the computer functions as the first image processing unit 11, the second image processing unit 12, the first estimating unit 13, the second estimating unit 51, the distributing unit 52 and the fifth image processing unit 53, and performs processing.

Also, the program according to the second example embodiment may be executed by a computer system constructed by a plurality of computers. In this case, each computer may function as any of the first image processing unit 11, the second image processing unit 12, the first estimating unit 13, the second estimating unit 51, the distributing unit 52 and the fifth image processing unit 53.

### First Working Example

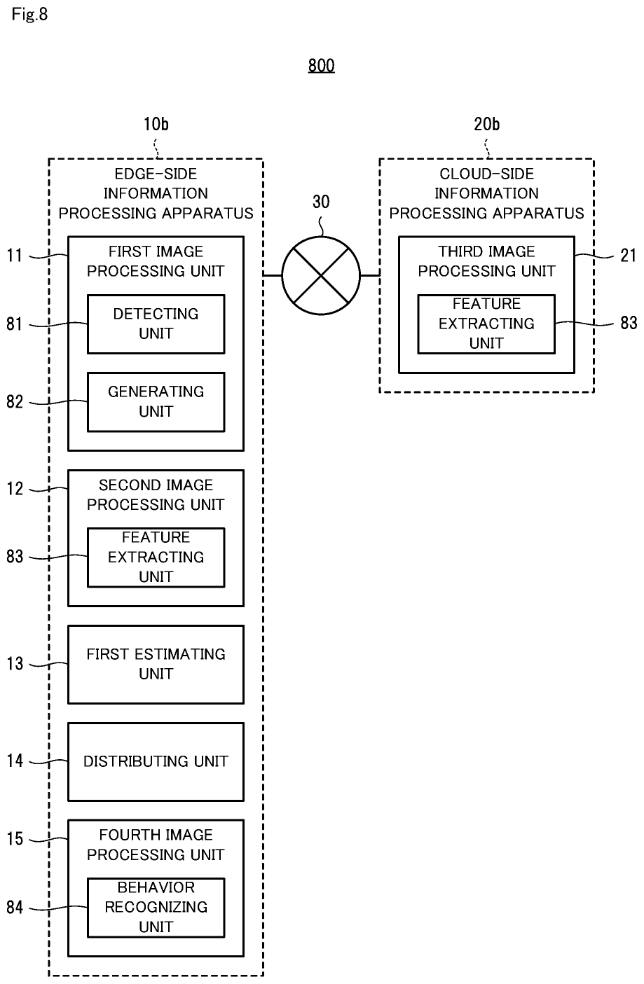

In a first working example will be described in detail using FIG. 8. FIG. 8 is a diagram for describing an example of the system of the first working example.

A system 800 is a system for realizing edge computing. The system 800 in FIG. 8 includes an information processing apparatus 10b provided on the edge side, an information processing apparatus 20b provided on the cloud side, and the network 30. Also, the information processing apparatus 10b and the information processing apparatus 20b communicate with each other via the network 30.

Note that the description of the pieces of hardware of the information processing apparatus 10b, information processing apparatus 20b, and network 30 is the same as that of the information processing apparatus 10, information processing apparatus 20, and network 30 in FIG. 1, and therefore the description thereof will be omitted.

The edge-side information processing apparatus 10b will be described.

The information processing apparatus 10b includes the first image processing unit 11, the second image processing unit 12, the first estimating unit 13, the distributing unit 14, and the fourth image processing unit 15, as shown in FIG. 8.

The first image processing unit 11 includes a detecting unit 81 and a generating unit 82. The second image processing unit 12 includes a feature extracting unit 83. The fourth image processing unit 15 includes a behavior recognizing unit 84.

The detecting unit 81 executes image processing for detecting object images corresponding to one or more objects that are captured in an image. The detecting unit 81 detects, from an image, object recognition information for identifying a detected object image and object position information representing the position of the object image on the image, for example. The detecting unit 81 estimates an object category (class) and a rectangle (bounding box) including positions at which the object is included.

The object recognition information is information (tracking ID) representing the object category (class) and the like. The object position information is information representing the rectangle (bounding box) including positions at which the object is included.

The generating unit 82 generates, for each processing period, first information by associating image identification information for identifying an image, object recognition information, and object position information with each other. The first information is generated for each image.

The feature extracting unit 83 generates second information by executing feature extraction processing for extracting a feature of each object image. The second information is a value in a multi-dimensional vector space, that is, a multi-dimensional vector amount, for example.

The behavior recognizing unit 84 acquires second information from the one of the second image processing unit 12 and the third image processing unit 21 that was quicker to generate the second information, and generates third information by executing behavior recognition processing using the second information. The behavior recognition processing is processing for recognizing behavior of an object, for example. Specifically, when the object is a person, behavior such as walking and dancing is recognized.

The cloud-side information processing apparatus 20b will be described.

As shown in FIG. 8, the information processing apparatus 20b includes the aforementioned third image processing unit 21. The third image processing unit 21 includes the aforementioned feature extracting unit 83.

Note that, in the example in FIG. 8, the fourth image processing unit 15 is provided in the edge-side information processing apparatus 10b, but may be provided in the cloud-side information processing apparatus 20b.

### Second Working Example

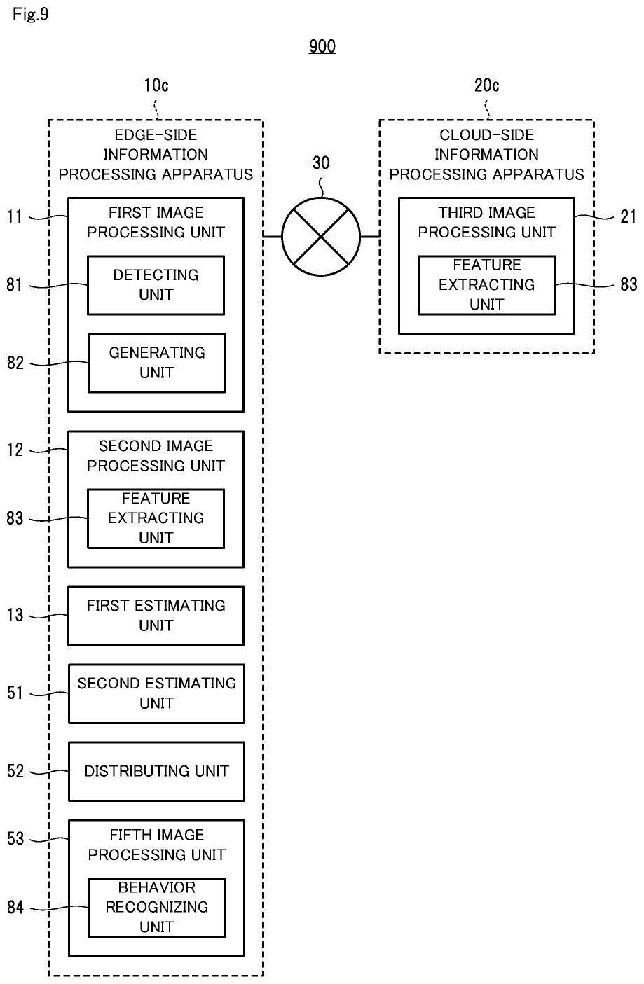

In a second working example will be described in detail using FIG. 9. FIG. 9 is a diagram for describing an example of the system of the second working example.

A system 900 is a system for realizing edge computing. The system 900 in FIG. 9 includes an information processing apparatus 10c provided on the edge side, an information processing apparatus 20c provided on the cloud side, and the network 30. Also, the information processing apparatus 10c and the information processing apparatus 20c communicate with each other via the network 30.

Note that the description of the pieces of hardware of the information processing apparatus 10c, information processing apparatus 20c, and network 30 is the same as that of the information processing apparatus 10, information processing apparatus 20, and network 30 in FIG. 1, and therefore the description thereof will be omitted.

The edge-side information processing apparatus 10c will be described.

The information processing apparatus 10c includes the first image processing unit 11, the second image processing unit 12, the first estimating unit 13, the distributing unit 52, and the fifth image processing unit 53, as shown in FIG. 9.

The first image processing unit 11 includes the detecting unit 81 and the generating unit 82. The second image processing unit 12 includes the feature extracting unit 83. The fifth image processing unit 53 includes the behavior recognizing unit 84. Note that the detecting unit 81, the generating unit 82, the feature extracting unit 83, and the behavior recognizing unit 84 have been described in working example 1, and therefore the description thereof will be omitted.

The second estimating unit will be described.

If it is estimated that the second image processing cannot be completed in the current processing period T0_1, for example, the second estimating unit 51 in working example 2 may estimate whether or not a spare period is present in the next processing period based on the difference between the number of object images in the first image and the number of object images in the second image.

Specifically, if a difference Sub2 between the number of object images in the first image and the number of object images in the second image is a preset threshold Thb or less (Sub2≤Thb), it is estimated that a spare period is present. Note that it is conceivable that the difference threshold Thb is determined through experiments, simulation, or the like.

Also, if it is estimated that the second image processing cannot be completed in the current processing period T0_1, for example, the second estimating unit 51 in working example 2 may estimate whether or not a spare period is present in the next processing period based on inter-frame movement amounts of object images from the first image to the second image.

Specifically, first, for each of one or more target object images in the first image, an inter-frame movement amount Mov of the target object image, which is an amount of movement from the first image to the second image, is calculated, and the calculated inter-frame movement amounts Mov are added up. Next, if the inter-frame movement amount MovTol obtained by the adding up is a preset threshold Thc or less (MovTol≤Thc), it is estimated that a spare period is present. Note that it is conceivable that the difference threshold Thc is determined through experiments, simulation, or the like.

The inter-frame movement amount Mov represents a total sum or an average value of movement distances, between the first image and the second image, of center positions (center points) of bounding boxes of object images having the same object recognition information.

As described above, when the change in number of object images (objects) corresponding to a target object is small, and the movements (intra-camera position movement amounts) of the objects are small, it is highly possible that the change between images in the next processing period and images in the current processing period will be small, and therefore a past result can be used, as the result of the second image processing, without performing the second image processing, for example, and it can be estimated that the second image processing (feature extraction processing) time in the next processing period decreases. Therefore, it can be determined that a spare period for executing second image processing (feature extraction processing) that remains unprocessed in the current processing period is present.

In contrast, when the change in number of object images is large, and the movements of the objects are large, it is highly possible that the change between images in the next processing period and images in the current processing period will be large, and it can be estimated that the second image processing (feature extraction processing) time in the next processing period increases, or cannot be reduced. Therefore, it can be determined that there is no spare period for executing second image processing (feature extraction processing) that remains unprocessed in the current processing period.

The cloud-side information processing apparatus 20c will be described.

The information processing apparatus 20c includes the aforementioned third image processing unit 21, as shown in FIG. 9. The third image processing unit 21 includes the aforementioned feature extracting unit 83.

Note that, in the example in FIG. 9, the fifth image processing unit 53 is provided in the edge-side information processing apparatus 10c, but may be provided in the cloud-side information processing apparatus 20c.

[Physical Configuration]

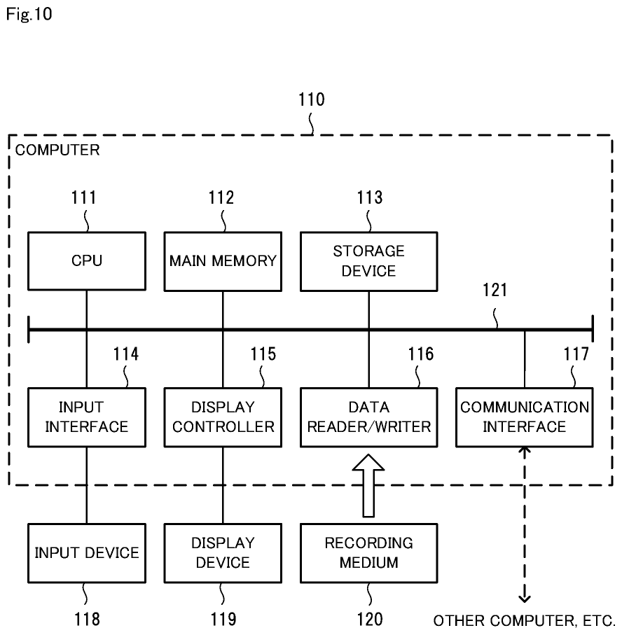

Here, a computer that executes a program according to the first and second example embodiments and the first and second working examples to realize an information processing apparatus will be described with reference to FIG. 10. FIG. 10 is a diagram for describing an example of a computer that realizes the information processing apparatus the information processing apparatus according to the first and second example embodiments and the first and second working examples.

As shown in FIG. 10, a computer 110 includes a CPU 111, a main memory 112, a storage device 113, an input interface 114, a display controller 115, a data reader/writer 116, and a communication interface 117. These units are connected via bus 121 so as to be able to perform data communication with each other. Note that the computer 110 may include a GPU or a FPGA in addition to the CPU 111 or instead of the CPU 111.

The CPU 111 loads a program (codes) according to the first and second example embodiments and the first and second working examples stored in the storage device 113 to the main memory 112, and executes them in a predetermined order to perform various kinds of calculations. The main memory 112 is typically a volatile storage device such as a DRAM (Dynamic Random Access Memory). Also, the program according to the first and second example embodiments and the first and second working examples are provided in the state of being stored in a computer-readable recording medium 120. Note that the program according to the first and second example embodiments and the first and second working examples may be distributed on the Internet that is connected via the communication interface 117.

Specific examples of the storage device 113 include a hard disk drive, and a semiconductor storage device such as a flash memory. The input interface 114 mediates data transmission between the CPU 111 and the input device 118 such as a keyboard or a mouse. The display controller 115 is connected to a display device 119, and controls the display of the display device 119.

The data reader/writer 116 mediates data transmission between the CPU 111 and the recording medium 120, and reads out the program from the recording medium 120 and writes the results of processing performed in the computer 110 to the recording medium 120. The communication interface 117 mediates data transmission between the CPU 111 and another computer.

Specific examples of the recording medium 120 include general-purpose semiconductor storage devices such as a CF (Compact Flash (registered trademark)) and a SD (Secure Digital), a magnetic recording medium such as a flexible disk, and an optical recording medium such as a CD-ROM (Compact Disk Read Only Memory).

The information processing apparatus according to the first and second example embodiments and the first and second working examples can also be achieved using hardware corresponding to the components, instead of a computer in which a program is installed. Furthermore, a part of the information processing apparatus may be realized by a program and the remaining part may be realized by hardware.

Although the invention of this application has been described with reference to the first and second example embodiments and the first and second working examples, the invention of this application is not limited to the above example embodiment. Within the scope of the invention of this application, various changes that can be understood by those skilled in the art can be made to the configuration and details of the invention of this application.

As described above, according to the present disclosure, if it is estimated that the processing on the edge side cannot be completed in a predetermined period, distributing the unprocessed portion of the remaining processing to the cloud side based on the processing content, and thus it is possible to reduce the processing delay. In addition, it is useful in a technical field of edge computing.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing apparatus comprising:
a first image processing unit that generates first information by executing first image processing on an image acquired in each preset processing period;
a second image processing unit that generates second information by executing second image processing using the first information in the processing period;
a first estimation unit that estimates whether or not the second image processing is able to be completed in a current processing period based on time needed for the first image processing and the first information; and
a distribution unit that distributes, if it is estimated that the second image processing is not able to be completed in the current processing period, the first information to be used in remaining second image processing to the second image processing unit and a third image processing unit that is provided separately from the second image processing unit and executes the second image processing, in order to execute the remaining second image processing in a preset number of processing periods after the current processing period.

2. The information processing apparatus according to claim 1,
wherein the distribution unit distributes all of the first information to be used in the remaining second image processing in the preset number of processing periods after the current processing period to the second image processing means and the third image processing unit, and
the second image processing unit, if a spare period is present in which the remaining second image processing is able to be executed in the preset number of processing periods after the current processing period, executes the second image processing using the first information to be used in the remaining second image processing in the spare period.

3. The information processing apparatus according to claim 2, further comprising
a fourth image processing unit that acquires second information generated in the remaining second image processing from one of the second image processing unit and the third image processing unit that was quicker to complete the remaining second image processing, and executing third image processing using the acquired second information.

4. The information processing apparatus according to claim 1, further comprising
a second estimation unit that, if it is estimated that the second image processing is not able to be completed in the current processing period, estimates, based on a change between a first image acquired in a processing period after the current processing period and a second image acquired in a processing period prior to the processing period, whether or not a spare period in which the remaining second image processing is executable is present in the processing period.

5. The information processing apparatus according to claim 4,
wherein the second image processing unit, if it is estimated that the spare period is present, executes the second image processing using the first information to be used in the remaining second image processing in the spare period, and
the distribution unit, if it is estimated that the spare period is not present, distributes the first information to be used in the remaining second image processing to the third image processing unit.

6. The information processing apparatus according to claim 5, wherein the third image processing unit executes the second image processing using the distributed first information.

7. The information processing apparatus according to claim 6, further comprising
a fifth image processing unit for acquiring second information generated by the second image processing unit and the third image processing unit, and executing third image processing using the acquired second information.

8. The information processing apparatus according to claim 4, wherein the second estimation unit estimates whether or not the spare period is present based on differences between pixels of the first image and pixels of the second image.

9. An information processing method comprising:
generating first information by executing first image processing on an image acquired in each preset processing period;
generating second information by executing second image processing using the first information in the processing period;
estimating whether or not the second image processing is able to be completed in a current processing period based on time needed for the first image processing and the first information; and
distributing, if it is estimated that the second image processing is not able to be completed in the current processing period, the first information to be used in remaining second image processing to the information processing apparatus and another information processing apparatus that is provided separately from the information processing apparatus and executes the second image processing, in order to execute the remaining second image processing in a preset number of processing periods after the current processing period.

10. A non-transitory computer-readable recording medium that includes a program recorded thereon, the program including instructions that causes a computer to carry out:
generating first information by executing first image processing on an image acquired in each preset processing period;
generating second information by executing second image processing using the first information in the processing period;
estimating whether or not the second image processing is able to be completed in a current processing period based on time needed for the first image processing and the first information; and
distributing, if it is estimated that the second image processing is not able to be completed in the current processing period, the first information to be used in remaining second image processing to the computer and another computer that is provided separately from the computer and executes the second image processing, in order to execute the remaining second image processing in a preset number of processing periods after the current processing period.
